(19) United States
(12) Patent Application Publication
(10) Pub. No.: US 2015/0128272 A1
(43) Pub. Date: May 7, 2015

(54) SYSTEM AND METHOD FOR FINDING PHISHING WEBSITE

(71) Applicant: BEIJING QIHOO TECHNOLOGY COMPANY LIMITED, Beijing (CN)

(72) Inventor: Yingying Chen, Beijing (CN)

(21) Appl. No.: 14/411,089

(22) PCT Filed: May 21, 2013
(86) PCT No.: PCT/CN2013/075950

§ 371 Date: Dec. 23, 2014

(30) Foreign Application Priority Data
Jun. 28, 2012 (CN) 201210220826.X

(51) Int. Cl. H04L 29/06; G06F 17/30

(52) U.S. Cl. CPC H04L 63/1483; G06F 17/30864
USPC 726/23

(57) ABSTRACT

Disclosed are a system and method for finding a phishing website. The system comprises: a seed library establishing unit, configured to place the original link of a target web page having the number of hits on known phishing websites that is greater than a predetermined threshold value into a seed library as a seed link; a seed extractor, configured to extract the seed link from the seed library; a seed web page analyzer, configured to find a corresponding seed web page according to the extracted seed link, and analyze the seed web page to acquire a suspicious link found in the seed web page; a judgement unit, configured to find a suspicious web page corresponding to the suspicious link, and judge whether the suspicious web page is a phishing website; and an output interface, configured to output the corresponding phishing website when the suspicious web page is a phishing website. The system and method greatly increase the speed in finding the phishing website, and reduce the security risks for the netizens to use the Internet.

### TECHNICAL FIELD

The present invention relates to the field of network security technology, and in particular, to a system and method for finding a phishing website.

### BACKGROUND ART

With the development of Internet, the number of netizens increases year by year. In addition to threat of traditional Trojans, viruses and the like, the number of phishing websites increases drastically on the Internet in the past two years. A great number of more than 100 thousands of new websites and billions of new URLs are generated on the internet every day. Therefore, except for accurately identifying the phishing website, the speed of finding the phishing website becomes more and more important. Many Internet companies are committed to solving such a problem: how to find the phishing website before it is largely spread or even before it begins to spread.

The existing technology of finding a phishing website usually exploits the following two manners: monitoring web pages of search engine with specified keywords; and monitoring and identifying the addresses that are rarely visited by netizens in combination with a client.

Both of the two manners of monitoring web pages of search engine with specified keywords and monitoring the addresses that are rarely visited by the netizens in combination with the client have time-lag. Especially in the second manner, these addresses could not be found until they are visited by the netizens, while the netizens who first visited the phishing website may have been already tricked.

### SUMMARY OF THE INVENTION

In view of the above problems, the present invention is to provide a system and method for finding a phishing website, to overcome the above problems or at least partially solve or relieve the above problems.

According to one aspect of the invention, a system is provided for finding a phishing website, comprising: a seed library establishing unit, configured to place the original link of a target web page having the number of hits on known phishing websites that is greater than a predetermined threshold value into a seed library as a seed link; a seed extractor, configured to extract the seed link from the seed library; a seed web page analyzer, configured to find a corresponding seed web page on the basis of the extracted seed link, and analyze the seed web page to acquire a suspicious link found in the seed web page; a judgement unit, configured to find a suspicious web page corresponding to the suspicious link and judge whether the suspicious web page is a phishing website; and an output interface, configured to output the corresponding phishing website when the suspicious web page is a phishing website.

According to another aspect of the invention, it is provided a method for finding a phishing website, comprising steps of: A: placing the original link of a target web page having the number of hits on known phishing websites that is greater than a predetermined threshold value into the seed library as a seed link; B: extracting the seed link from the seed library, and gathering suspicious link found in the seed web page corresponding to the seed link; and C: outputting the corresponding phishing website when the suspicious web page corresponding to the suspicious link is a phishing website.

According to still another aspect of the invention, it is provided a computer program, comprising computer readable code, wherein a server executes the method for finding a phishing website(s) according to any one of claims 6-11 when the computer readable code is operated on the server.

According to still another aspect of the invention, it is provided a computer readable medium, in which the computer program according to claim 12 is stored.

Advantages of the invention are as follows:

The system and method for finding a phishing website according to the invention, based on a feature that the phishing websites are generally spread through advertisements, secret links SEO (Search Engine Optimization) and the like, may utilize the blacklist library of the known phishing websites to obtain seed web page and may find out a new phishing website by regularly detecting the seed web page, greatly increasing the speed in finding the phishing website and reducing the security risk for the netizens to use the Internet.

The above description is merely a generalization of the technical solution of the present invention. In order to make the technical solution of the present invention more understandable so that it can be implemented in accordance with the contents of the description, and to make the foregoing and other objects, features and advantages of the invention to be more apparent, detailed embodiments of the invention will be provided below.

### BRIEF DESCRIPTION OF THE DRAWINGS

Through reading the detailed description of the following preferred embodiments, various further advantages and benefits will become apparent to an ordinary skilled in the art. Drawings are merely provided for the purpose of illustrating the preferred embodiments and are not intended to limit the invention. Further, throughout the drawings, same elements are indicated by same reference numbers. In the drawings:

FIG. 1 is a schematic block diagram showing a system for finding a phishing website according to a first embodiment of the present invention;

FIG. 2 is a schematic block diagram showing a seed library establishing unit;

FIG. 3 is a schematic block diagram showing a system for finding a phishing website according to a second embodiment of the present invention;

FIG. 4 is a flow chart showing a method for finding a phishing website according to a third embodiment of the present invention;

FIG. 5 is a flow chart of step A;

FIG. 6 is a flow chart of step B;

FIG. 7 is a flow chart of step C;

FIG. 8 schematically shows a block diagram of a server for executing the method according to the present invention; and

FIG. 9 schematically shows a memory cell for storing and carrying program codes for realizing the method according to the present invention.

### DETAILED DESCRIPTION OF THE EMBODIMENTS

Hereafter, the present invention will be further described in connection with the drawings and the specific embodiments.

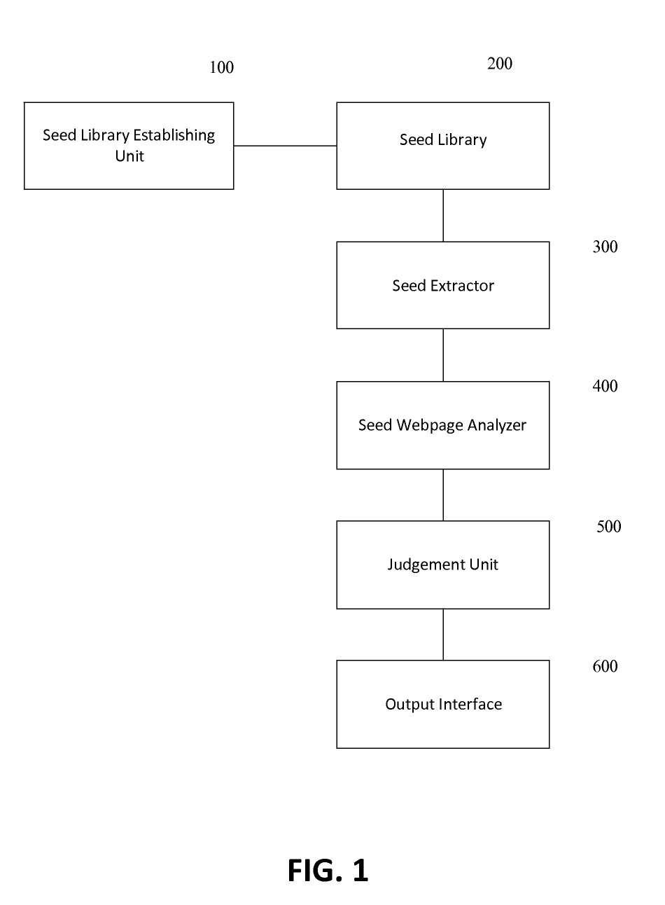

FIG. 1 is a schematic block diagram showing a system for finding a phishing website according to a first embodiment of the present invention. As shown in FIG. 1, the system may comprise: a seed library establishing unit 100, a seed library 200, a seed extractor 300, a seed web page analyzer 400, a judgement unit 500 and an output interface 600.

The seed library establishing unit 100 is configured to place the original link of a target web page having the number of hits on known phishing websites that is greater than a predetermined threshold value into the seed library as a seed link.

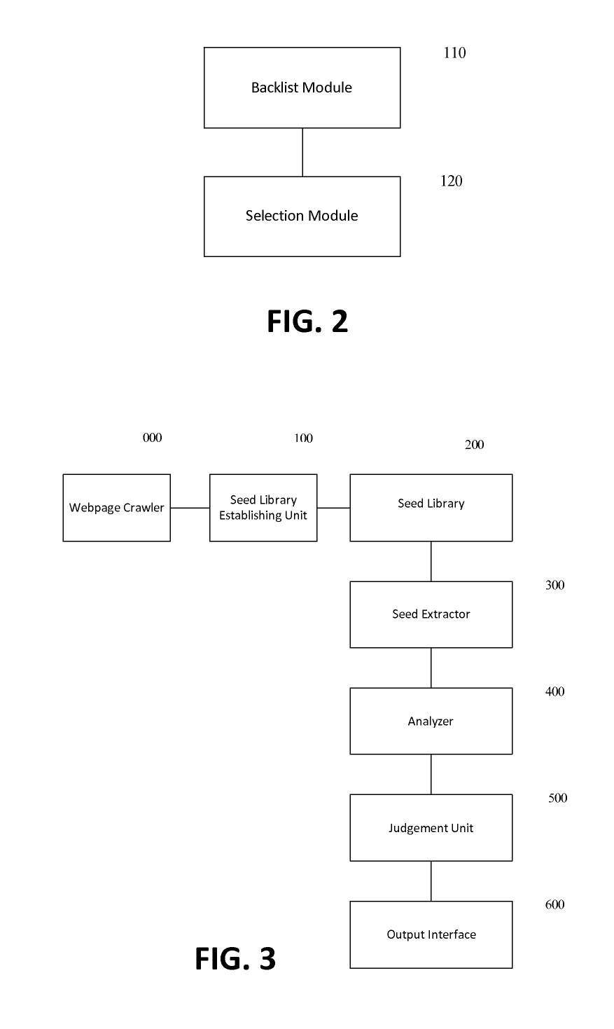

FIG. 2 is a schematic block diagram showing a seed library establishing unit. As shown in FIG. 2, the seed library establishing unit 100 may further include: a blacklist module 110 and a selection module 120.

The blacklist module 110 is configured to establish a blacklist library based on the known phishing websites. In order to ensure the accuracy of finding the phishing website, the blacklist library should contain the known phishing websites as much as possible, and will be constantly updated in practice to add the phishing website thereto.

The selection module 120 is configured to place the original link of the target web page into the seed library as the seed link when the number of hits in the target web pages on the known phishing websites in the blacklist library is greater than the predetermined threshold value. That is, in the case that all the links of the target web pages are considered as a first set and the domain names of the known phishing websites in the blacklist library are considered as a second set, an intersection of the first set and the second set are calculated, such that a number of elements in the intersection is considered as the number of hits in the target web pages on the known phishing websites in the blacklist library and the number is compared with the predetermined threshold value; if the number is greater than the predetermined threshold value, then the original link of the target web page will be placed into the seed library as the seed link; otherwise, the target web page will be discarded.

Herein, calculation formula of the number of hits in the target web pages on the known phishing websites in the blacklist library is as follows:

N=|M|;

M=W∩D;

wherein, W indicates a set of links contained in the target web page; D indicates a set of domain names of the known phishing websites in the blacklist library; M indicates an intersection of W and D; |M| indicates the number of elements in M; N indicates the number of hits in the target web pages on the known phishing websites in the blacklist library.

Herein, the predetermined threshold value can be set and adjusted according to the actual use, and usually can be set as 3, 4 or 5 (in this embodiment, preferably, 3).

The seed library 200 is configured to store the seed links. The number of the seed links in the seed library 200 is at least 1, and the number of seed links in the seed library 200 will be increased constantly in practice so as to improve the efficiency of finding a phishing website.

The seed extractor 300 is configured to extract the seed link from the seed library 200.

The seed web page analyzer 400 is configured to find a corresponding seed web page on the basis of the extracted seed link and analyze the seed web page to acquire a suspicious link found in the seed web page. The suspicious link is generally a new unknown link presented in the seed web page.

The judgement unit 500 is configured to find the suspicious web page corresponding to the suspicious link and judge whether the suspicious page is a phishing website. The determination technology used herein to the suspicious web page is well-known in the art, which is not a key point of the present invention and the description of which will be omitted.

The output interface 600 is configured to output the corresponding phishing website when the suspicious web page is a phishing website. The output interface 600 is also configured to update the blacklist library (that is, placing a newly found phishing website into the blacklist library) after outputting the corresponding phishing website.

FIG. 3 is a schematic block diagram showing a system for finding a phishing website according to a second embodiment of the present invention. As shown in FIG. 3, the system in this embodiment is substantially the same as that in the first embodiment, except that the system in this embodiment further includes a web page crawler 000, which is configured to crawl the target web page for the seed library establishing unit 100 to use it. A Web spider, a web crawler, a search robot or a web crawler script program, etc. can be used for the web page crawler 000.

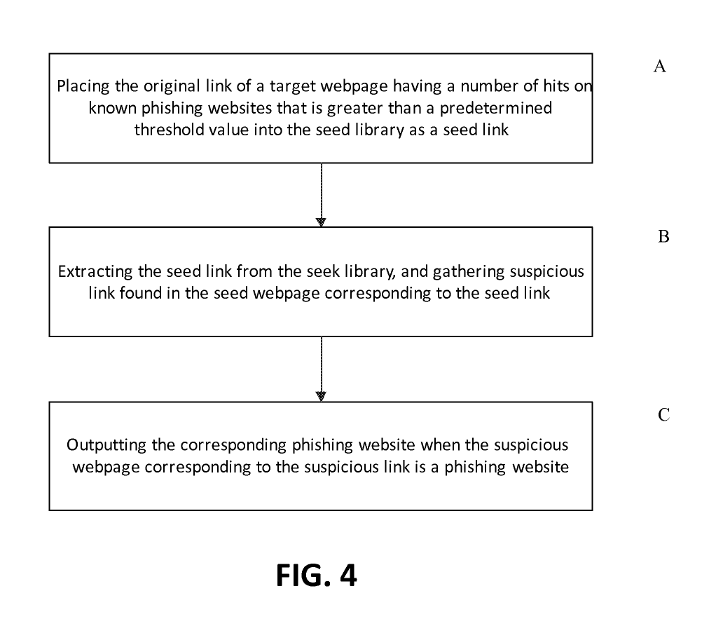

FIG. 4 is a flow chart showing a method for finding a phishing website according to a third embodiment of the present invention. As shown in FIG. 4, the method includes steps of:

A: placing the original link of a target web page having the number of hits on known phishing websites that is greater than a predetermined threshold value into the seed library as a seed link.

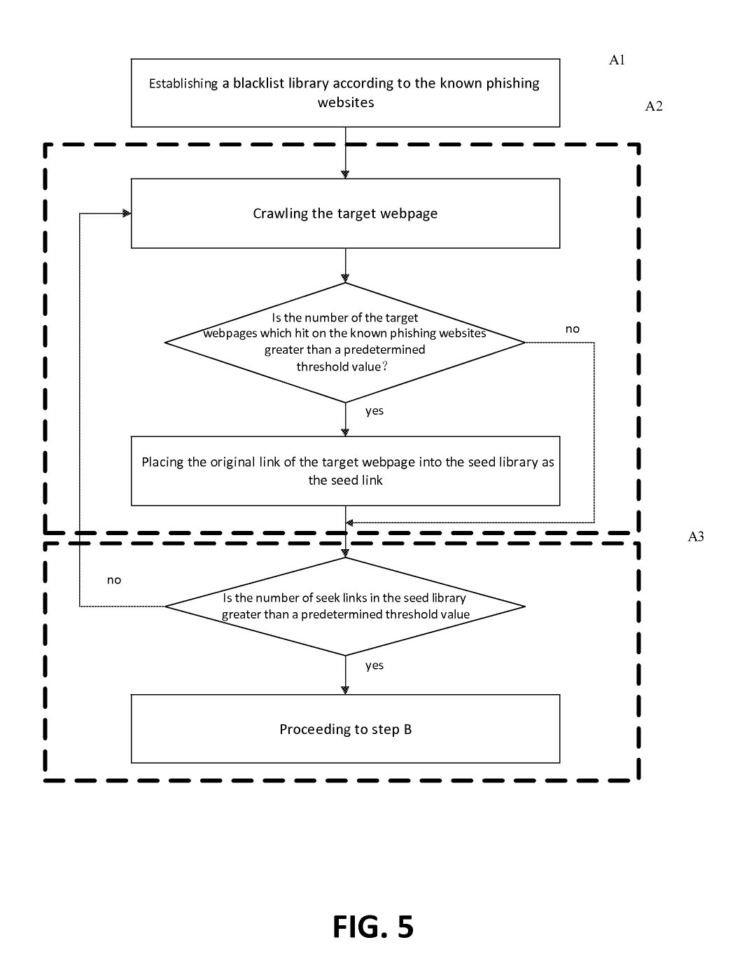

FIG. 5 is a flow chart of step A. As shown in FIG. 4, the step A further includes steps of:

A1: establishing a blacklist library according to the known phishing websites.

A2: crawling the target web page, judging whether the number of hits in the target web page on the known phishing websites is greater than a predetermined threshold value, if yes, placing the original link of the target web page into the seed library as the seed link and then proceeding to step A3; otherwise, directly proceeding to step A3.

A3: judging whether the number of seed links in the seed library is greater than a predetermined threshold value, if yes, proceeding to step B; otherwise, returning to step A2.

B: extracting the seed link from the seed library, and gathering suspicious link found in the seed web page corresponding to the seed link.

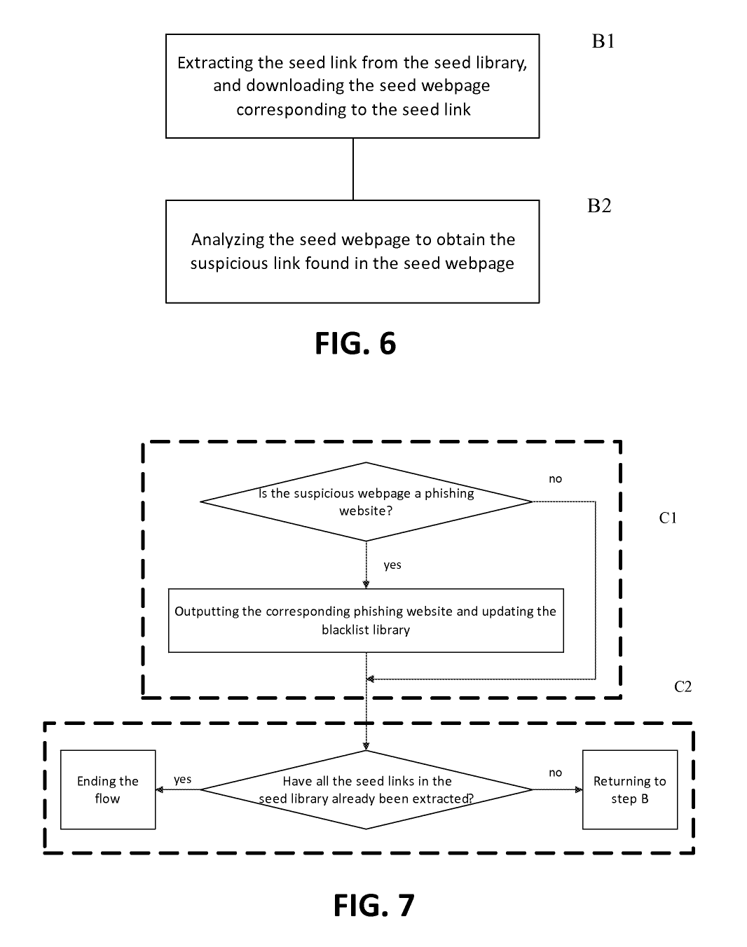

FIG. 6 is a flow chart of step B. As shown in FIG. 5, the step B further includes steps of:

B1: extracting the seed link from the seed library, and downloading the seed web page corresponding to the seed link;

B2: analyzing the seed web page to obtain the suspicious link found in the seed web page.

C: outputting the corresponding phishing website when the suspicious web page corresponding to the suspicious link is a phishing website.

FIG. 7 is a flow chart of step C. As shown in FIG. 7, the step C further includes steps of:

C1: judging whether the suspicious web page is a phishing website, if yes, outputting the corresponding phishing website and updating the blacklist library, and then proceeding to step C2; otherwise, directly proceeding to step C2.

C2: judging whether all the seed links in the seed library have already been extracted, if yes, ending the flow; otherwise, returning to the step B.

The system and method for finding a phishing website according to the embodiments of the invention, based on a feature that the phishing websites are generally spread through advertisements, secret links SEO (Search Engine Optimization) and the like, may utilize the blacklist library of the known phishing websites to obtain a seed web page and may find out new phishing websites by regularly detecting the seed web page, greatly increasing the speed in finding the phishing website and reducing the security risk for the netizens to use the Internet.

Each member embodiment of the present invention can be realized by hardware, or realized by software modules running on one or more processors, or realized by the combination thereof. A person skilled in the art should understand that a microprocessor or a digital signal processor (DSP) may be used in practice to realize some or all the functions of some or all the members of the system for finding a phishing website according to the embodiments of the present invention. The present invention may be further realized as some or all the equipments or device programs for executing the methods described herein (for example, computer programs and computer program products). This programs for realizing the present invention may be stored in a computer readable medium, or have one or more signal forms. These signals may be downloaded from the Internet websites, or be provided by carrying signals, or be provided in any other manners.

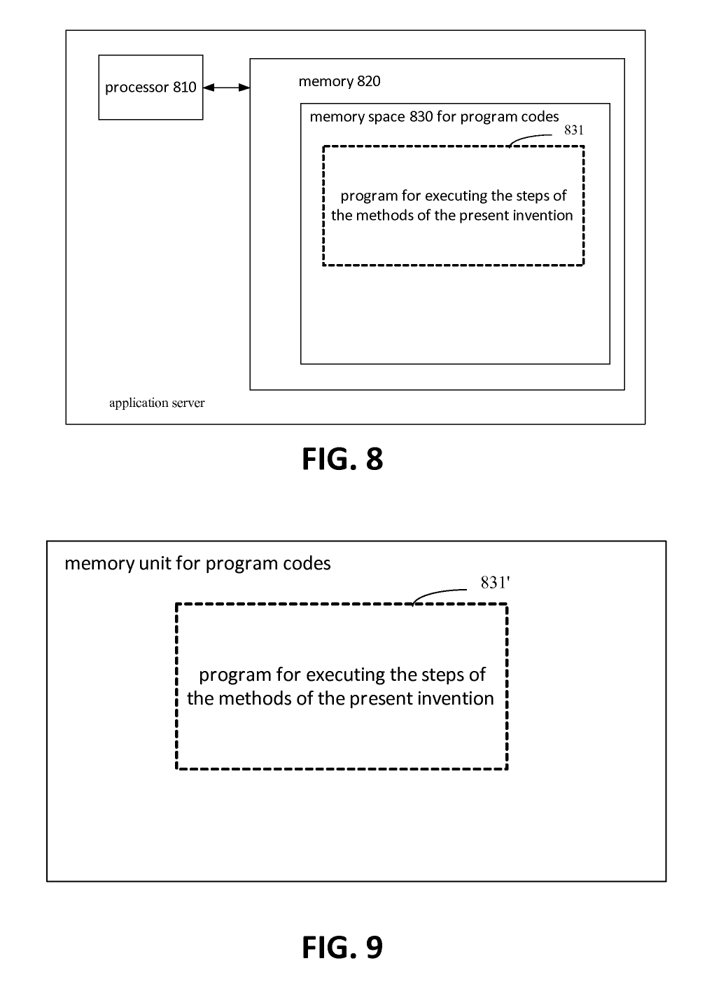

For example, FIG. 8 shows a server configured to realize the method for finding a phishing website according to the present invention, such as an application server. The server traditionally comprises a processor 810 and a computer program product or a computer readable medium in form of a memory 820. The memory 820 may be electronic memories such as flash memory, EEPROM (Electrically Erasable Programmable Read-Only Memory), EPROM (Erasable Programmable Read Only Memory), hard disk or ROM (Read Only Memory). The memory 820 has a memory space 830 of program code 831 for executing any method steps of the above method. For example, the memory space 830 for program code may comprise various program codes 831 of respective step for realizing the above mentioned method. These program codes may be read from one or more computer program products or be written into one or more computer program products. These computer program products comprise program code carriers such as hard disk, compact disk (CD), memory card or floppy disk. These computer program products are usually the portable or stable memory cells as shown in reference FIG. 9. The memory cells may have memory sections, memory spaces, etc., which are arranged similar to the memory 820 of the server as shown in FIG. 8. The program code may be compressed in an appropriate manner. Usually, the memory cell includes computer readable codes 831′, i.e., the codes can be read by processors such as 810. When the codes are operated by the server, the server may execute each step as described in the above method.

The terms “one embodiment”, “an embodiment” or “one or more embodiment” used herein means that, the particular feature, structure, or characteristic described in connection with the embodiments may be included in at least one embodiment of the present invention. In addition, it should be noticed that, for example, the wording “in one embodiment” used herein is not necessarily always referring to the same embodiment.

A number of specific details have been described in the specification provided herein. However, it should be understood that the embodiments of present invention may be implemented without these specific details. In some examples, in order not to confuse the understanding of the specification, the known methods, structures and techniques are not shown in detail.

It should be noticed that the above-described embodiments are intended to illustrate but not to limit the present invention, and alternative embodiments can be devised by the person skilled in the art without departing from the scope of claims as appended. In the claims, any reference symbols between brackets form no limit to the claims. The wording “comprising” is not meant to exclude the presence of elements or steps not listed in a claim. The wording “a” or “an” in front of element is not meant to exclude the presence of a plurality of such elements. The present invention may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as names.

Also, it should be noticed that the language used in the present specification is chosen for the purpose of readability and teaching, rather than for the purpose of explaining or defining the subject matter of the present invention. Therefore, it is obvious for an ordinary skilled person in the art that modifications and variations could be made without departing from the scope and spirit of the claims as appended. For the scope of the present invention, the disclosure of present invention is illustrative but not restrictive, and the scope of the present invention is defined by the appended claims.

1. A system for finding a phishing website, comprising:
a seed library establishing unit, configured to place the original link of a target web page having the number of hits on known phishing websites that is greater than a predetermined threshold value into a seed library as a seed link;
a seed extractor, configured to extract the seed link from the seed library;
a seed web page analyzer, configured to find a corresponding seed web page according to the extracted seed link, and analyze the seed web page to acquire a suspicious link found in the seed web page;
a judgement unit, configured to find a suspicious web page corresponding to the suspicious link, and judge whether the suspicious web page is a phishing website; and
an output interface, configured to output the corresponding phishing website when the suspicious web page is a phishing website.

2. The system according to claim 1, wherein the system further comprises:
a web page crawler, configured to crawl the target web page.

3. The system according to claim 1, wherein the seed library establishing unit further comprises:
a blacklist module, configured to establish a blacklist library based on the known phishing websites; and
a selection module, configured to place the original link of the target web page into the seed library as the seed link when the number of hits in the target web page on the known phishing websites in the blacklist library is greater than the predetermined threshold value.

4. The system according to claim 3, wherein the output interface is also configured to update the blacklist library after outputting the corresponding phishing website.

5. The system according to claim 3, wherein calculation formula of the number of hits in the target web page on the known phishing websites in the blacklist library is as follows:
N=|M|;
M=W∩D;
wherein, W indicates a set of links contained in the target web page; D indicates a set of domain names of the known phishing websites in the blacklist library; M indicates an intersection of W and D; |M| indicates the number of elements in M; N indicates the number of hits in the target web page on the known phishing websites in the blacklist library.

6. A method for finding a phishing website, comprising steps of:
A: placing the original link of a target web page having the number of hits on known phishing websites that is greater than a predetermined threshold value into the seed library as a seed link;
B: extracting the seed link from the seed library, and gathering suspicious link found in the seed web page corresponding to the seed link; and
C: outputting the corresponding phishing website when the suspicious web page corresponding to the suspicious link is a phishing website.

7. The method according to claim 6, wherein the step of placing the original link of a target web page having the number of hits on known phishing websites that is greater than a predetermined threshold value into the seed library as a seed link, further includes:
A2: crawling the target web page, judging whether the number of hits in the target web page on the known phishing websites is greater than a predetermined threshold value, if yes, placing the original link of the target web page into the seed library as the seed link and then proceeding to step A3; otherwise, directly proceeding to step A3; and
A3: judging whether the number of seed links in the seed library is greater than a predetermined threshold value, if yes, proceeding to step B; otherwise, returning to step A2.

8. The method according to claim 7, wherein before the step A2, the method further comprises a step A1: establishing a blacklist library according to the known phishing websites and
in the step A2, the step of judging whether the number of hits in the target web page on the known phishing websites is greater than a predetermined threshold value further comprises:
judging whether the number of hits in the target web page on the known phishing websites in the blacklist library is greater than a predetermined threshold value.

9. The method according to claim 8, wherein calculation formula of the number of hits in the target web page on the known phishing websites in the blacklist library is as follows:
N=|M|;
M=W∩D;
wherein, W indicates a set of links contained in the target web page; D indicates a set of domain names of the known phishing websites in the blacklist library; M indicates an intersection of W and D; |M| indicates the number of elements in M; N indicates the number of hits in the target web page on the known phishing websites in the blacklist library.

10. The method according to claim 8, wherein the step of outputting the corresponding phishing website when the suspicious web page corresponding to the suspicious link is a phishing website, further comprises:
C1: judging whether the suspicious web page is a phishing website, if yes, outputting the corresponding phishing website and updating the blacklist library, and then proceeding to step C2; otherwise, directly proceeding to step C2; and
C2: judging whether all the seed links in the seed library have already been extracted, if yes, ending the flow; otherwise, returning to the step B.

11. The method according to claim 6, wherein the step of extracting the seed link from the seed library and gathering suspicious link found in the seed web page corresponding to the seed link, further comprises:
B1: extracting the seed link from the seed library, and downloading the seed web page corresponding to the seed link; and
B2: analyzing the seed web page to obtain the suspicious link found in the seed web page.

12. (canceled)

13. A non-transitory computer readable medium having instructions stored thereon that, when executed by at least one processor, causes the at least one processor to perform operations for finding a phishing website, which comprises the steps of: placing the original link of a target web page having the number of hits on known phishing websites that is greater than a predetermined threshold value into the seed library as a seed link;
extracting the seed link from the seed library, and gathering suspicious link found in the seed web page corresponding to the seed link; and
outputting the corresponding phishing website when the suspicious web page corresponding to the suspicious link is a phishing website.

14. The system according to claim 2, wherein the seed library establishing unit further comprises:
a blacklist module, configured to establish a blacklist library based on the known phishing websites; and
a selection module, configured to place the original link of the target web page into the seed library as the seed link when the number of hits in the target web page on the known phishing websites in the blacklist library is greater than the predetermined threshold value.

15. The system according to claim 14, wherein the output interface is also configured to update the blacklist library after outputting the corresponding phishing website.

16. The system according to claim 14, wherein calculation formula of the number of hits in the target web page on the known phishing websites in the blacklist library is as follows:
N=|M|;
M=W∩D;
wherein, W indicates a set of links contained in the target web page; D indicates a set of domain names of the known phishing websites in the blacklist library; M indicates an intersection of W and D; |M| indicates the number of elements in M; N indicates the number of hits in the target web page on the known phishing websites in the blacklist library.
